(19) United States
(12) Patent Application Publication
(10) Pub. No.: US 2016/0125448 A1
(43) Pub. Date: May 5, 2016

(54) System for Incentivizing Customer Loyalty Using Monthly and Annual Awards

(71) Applicant: Paul G. Begum, Laguna Niguel, CA (US)

(72) Inventor: Paul G. Begum, Laguna Niguel, CA (US)

(21) Appl. No.: 14/992,807

(22) Filed: Jan. 11, 2016

Related U.S. Application Data
(63) Continuation-in-part of application No. 13/297,009, filed on Nov. 15, 2011, now Pat. No. 8,788,551.

(51) Int. Cl. G06Q 30/02

(52) U.S. Cl. CPC G06Q 30/0226

(57) ABSTRACT

Customer loyalty to a retailer is incentivized using awards. Customers are incentivized to shop at a particular retail store by offering awards such as coupons or points redeemable for coupons to customers that have visited the retail store during a specified time period. A drawing or lottery can be used to select one or more winners of an award for each specified time period. Awards can be transmitted to a customer's mobile phone where the customer can redeem them upon purchasing a product.

### CROSS-REFERENCE TO RELATED APPLICATIONS

This application is a continuation-in-part of U.S. patent application Ser. No. 13/297,009 which was filed on Jun. 25, 2013 which claims the benefit of U.S. Provisional Patent Application No. 61/668,385 which was filed on Jul. 5, 2012.

### BACKGROUND

With the number of retail establishments that exist today, a retailer is constantly striving to attract and keep the attention of customers to encourage them to shop at its retail stores. At the same time, product manufacturers, as well as retail establishments that have their own line of products, are continually promoting their products to induce customers to purchase them.

A common way to induce a customer to select a particular brand of product to purchase is by offering coupons which provide the customer with a discount off of the listed price for the product. Although coupons are effective in promoting a particular brand of product, they are not always an effective way to attract customers to a particular store or chain of stores because coupons are often accepted at various different stores. For example, a coupon for a national brand of product X may be accepted by all major retail establishments in a particular area thus failing to provide an incentive to the customer to shop at any particular store.

### BRIEF SUMMARY

The present invention extends to systems, methods, and computer program products for incentivizing customer loyalty using monthly and annual awards. Customers are incentivized to shop at a particular retail store by offering awards such as coupons or points redeemable for coupons to customers that have visited the retail store during a specified time period and have activated their mobile phones and opened the coupon application on their portable computer device while in the store. A drawing or other randomization technique can be used to select one or more winners of an award for each specified time period.

In one embodiment, a method for incentivizing customer loyalty using awards comprises displaying a user interface on a portable computer device. The user interface includes a first user interface element that allows a user of the portable computer device to register a visit to a retail store when the portable computer device is located within a specified proximity to the retail store.

User input is then received that selects the first user interface element while the portable computer device is within the specified proximity to a first retail store. In response to the selection of the first user interface element, a first notification is transmitted to a server computer system. The first notification identifies the portable computer device and the first retail store.

The portable computer device then receives a second notification from the server computer system. The second notification from the server computer system specifies that the user of the portable computer device has been selected as a winner of a drawing, and also includes one or more coupons for products available at the first retail store as an award for winning the drawing. The one or more coupons are then displayed on the portable computer device.

In another embodiment, a method for incentivizing customer loyalty using awards comprises creating a pool of entries for a drawing by performing the following for each of a plurality of customers: (1) receiving a notification from a computer device, the notification identifying that a customer using the computer device has visited a retail store; and (2) adding an entry to the pool that identifies the customer.

After a one month of time, one of the entries from the pool is randomly selected. A notification is created to send to the computer device associated with the selected entry. The notification comprises one or more coupons for display by an application on the computer device associated with the selected entry. The notification is sent to the computer device associated with the selected entry thereby notifying the customer using the computer device that the customer has won the one or more coupons as an award for having visited the retail store during the specified period of time.

Another embodiment of the present invention records and reports to a server the number of times that an application on the portable computer device has been activated in a qualifying store. If that number exceeds a predetermined minimum, the participant will be sent by the server a message that they have qualified for an award. Receipt of a monthly award also qualifies them as a candidate for an annual randomized award.

In another embodiment, a daily award is offered by the store, and a monthly award is offered by a third party such as one of the companies offering the coupons. Points are awarded to the individual every time the coupon application is opened. These points allow the user greater opportunities to win a monthly award. The points can be allocated such that every x points allows one entry, so that more points provide more entries and a greater likelihood of winning. The points are only allocated if the application is opened and used in a qualified or participating store. Use is verified at the check-out counter or point of sale when digital coupons are used.

Similarly, points aggregate to provide greater chances of winning an annual award. This award is also provided by a third party, and is large enough to incentivize use of the application in stores. Qualification may follow the same scheme as the monthly award, or may use another formula to allow the points to increase the probability of winning.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment for incentivizing customer loyalty using awards;

FIG. 2 illustrates an exemplary user interface of a mobile application for registering a visit to a store;

FIG. 3 illustrates an exemplary user interface of a mobile application for displaying a store where a customer is detected to be;

FIG. 4 illustrates an exemplary user interface of a mobile application for allowing a customer to select coupons to redeem at checkout;

FIG. 5 illustrates an exemplary user interface of a mobile application for allowing a customer to redeem a coupon using a barcode;

FIG. 6 illustrates an exemplary user interface of a mobile application that displays a customer's points;

FIG. 7 illustrates a flowchart of an exemplary method for participating in an award drawing;

FIG. 8 illustrates a flowchart of an exemplary method for incentivizing customer loyalty using awards; and

FIG. 9 illustrates a flowchart of a monthly award program.

### DETAILED DESCRIPTION

The present invention extends to systems, methods, and computer program products for incentivizing customer loyalty using monthly and annual awards. Customers are incentivized to shop at a particular retail store by offering awards such as coupons or points redeemable for coupons to customers that have visited the retail store during a specified time period and have activated their mobile phones and opened the coupon application on their portable computer device while in the store. A drawing or other randomization technique can be used to select one or more winners of an award for each specified time period.

In one embodiment, a method for incentivizing customer loyalty using awards comprises displaying a user interface on a portable computer device. The user interface includes a first user interface element that allows a user of the portable computer device to register a visit to a retail store when the portable computer device is located within a specified proximity to the retail store.

User input is then received that selects the first user interface element while the portable computer device is within the specified proximity to a first retail store. In response to the selection of the first user interface element, a first notification is transmitted to a server computer system. The first notification identifies the portable computer device and the first retail store.

The portable computer device then receives a second notification from the server computer system. The second notification from the server computer system specifies that the user of the portable computer device has been selected as a winner of a drawing, and also includes one or more coupons for products available at the first retail store as an award for winning the drawing. The one or more coupons are then displayed on the portable computer device.

In another embodiment, a method for incentivizing customer loyalty using awards comprises creating a pool of entries for a drawing by performing the following for each of a plurality of customers: (1) receiving a notification from a computer device, the notification identifying that a customer using the computer device has visited a retail store; and (2) adding an entry to the pool that identifies the customer.

After a one month of time, one of the entries from the pool is randomly selected. A notification is created to send to the computer device associated with the selected entry. The notification comprises one or more coupons for display by an application on the computer device associated with the selected entry. The notification is sent to the computer device associated with the selected entry thereby notifying the customer using the computer device that the customer has won the one or more coupons as an award for having visited the retail store during the specified period of time.

Another embodiment of the present invention records and reports to a server the number of times that an application on the portable computer device has been activated in a qualifying store. If that number exceeds a predetermined minimum, the participant will be sent by the server a message that they have qualified for an award. Receipt of a monthly award also qualifies them as a candidate for an annual randomized award.

In another embodiment, a daily award is offered by the store, and a monthly award is offered by a third party such as one of the companies offering the coupons. Points are awarded to the individual every time the coupon application is opened. These points allow the user greater opportunities to win a monthly award. The points can be allocated such that every x points allows one entry, so that more points provide more entries and a greater likelihood of winning. The points are only allocated if the application is opened and used in a qualified or participating store. Use is verified at the check-out counter or point of sale when digital coupons are used.

Similarly, points aggregate to provide greater chances of winning an annual award. This award is also provided by a third party, and is large enough to incentivize use of the application in stores. Qualification may follow the same scheme as the monthly award, or may use another formula to allow the points to increase the probability of winning.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

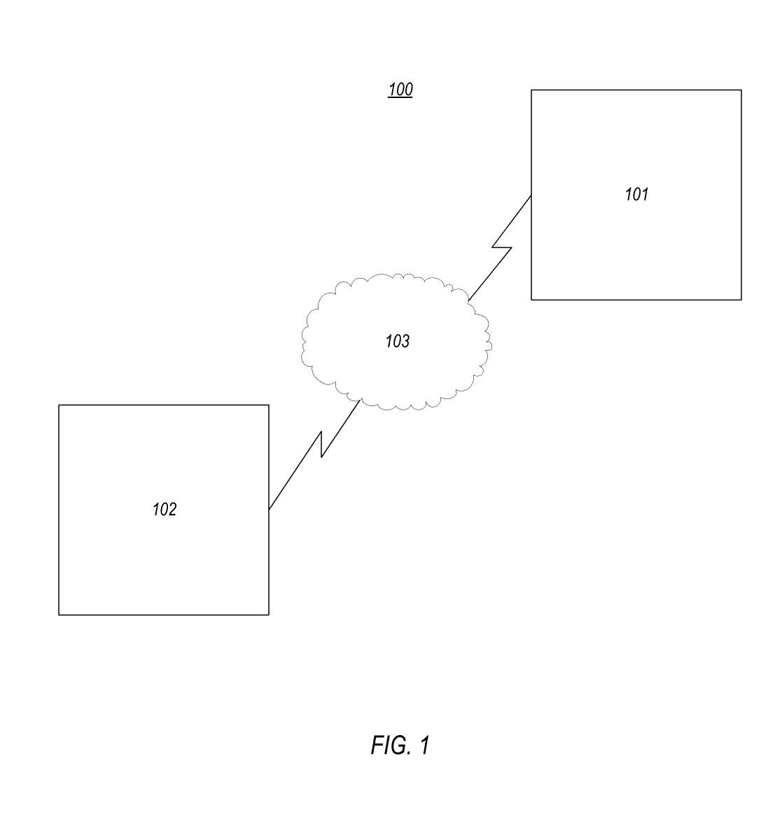

FIG. 1 illustrates an exemplary computing environment 100 for incentivizing customer loyalty using awards. Computing environment 100 includes computer system 101 and computer device 102 that are connected by network 103. Computer system 101 can comprise one or more servers or other computer devices. For example, computer system 101 can represent a cloud of servers. Computer device 102 can represent a customer's computer device such as a mobile phone or other portable electronic device capable of communicating with computer system 101.

In general, a customer uses computer device 102 to send communications to and receive communications from computer system 101 regarding a customer loyalty awards program as will be further described below. These communications can be transmitted using any suitable format or protocol for communicating between computer systems. Portions of computer system 101 can be located within a particular retail store, or may be completely located outside of a particular retail store (e.g. in the cloud). Accordingly, the particular architecture used to implement the award program of the present invention is not essential to the invention.

When a customer arrives at a retail store, the customer can notify computer system 101 of the customer's visit to the retail store. In some embodiments, a customer can scan a loyalty card or provide some other type of unique identifier as input to a component of computer system 101 located within the retail store. Alternatively, a customer can use a mobile application on computer device 102 to “check in” with computer system 101.

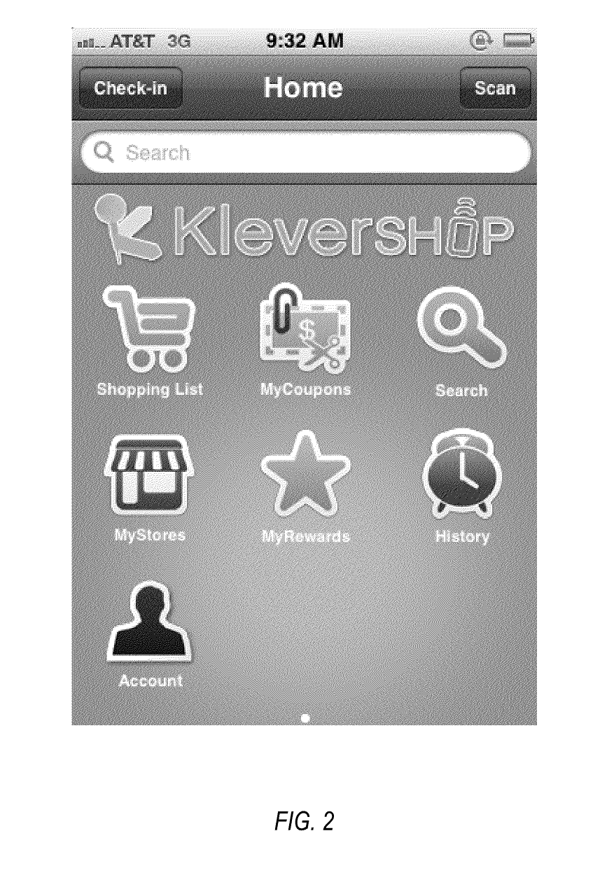

FIG. 2 illustrates a user interface 200 of an exemplary mobile application that can be used to send notifications to computer system 101 of a customer's visit to a particular retail store. As shown, user interface 200 includes a Check In button 201 that a user can select when at or within proximity of a retail store. Selection of Check In button 201 causes a notification of the customer's presence at the store to be sent to computer system 101.

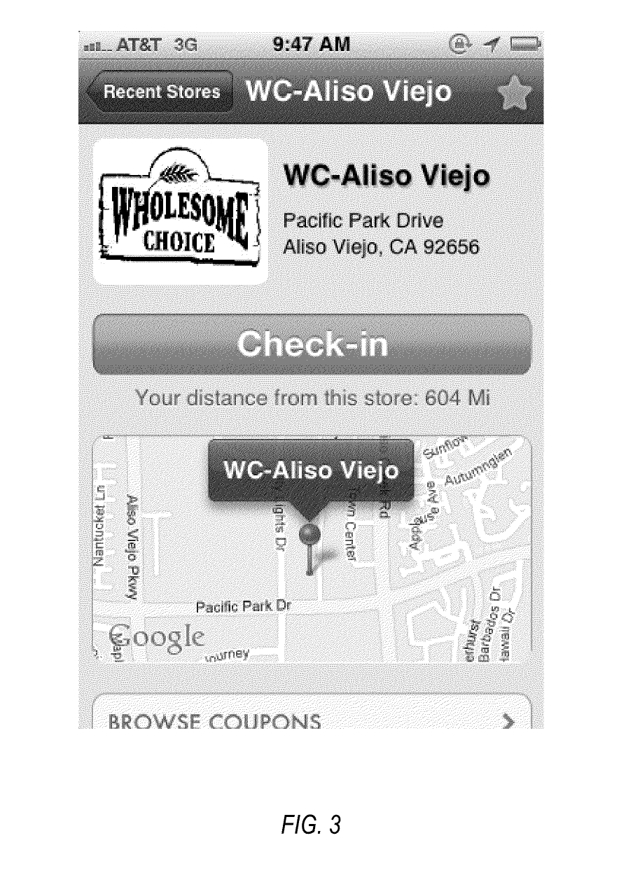

The mobile application on computer device 102 can be configured to automatically detect at which store a customer is located using GPS data or by detecting a signal transmitted within the store. For example, FIG. 3 illustrates a user interface of an exemplary mobile application that can display a store where the customer is detected to be. The mobile application may also be configured to accept user input that specifies at which store the customer is located. For example, a code or other identifier could be provided to the customer upon entering the store that can be input to computer device 102. The code or identifier can be in the form of a scannable barcode that the customer scans with computer device 102 to automatically generate the notification of the customer's presence. Alternatively, the code or identifier can require manual input to computer device 102.

When computer system 101 receives a notification from computer device 102 that the customer has visited a particular store, computer system 101 can store an indication that the customer has visited the particular store. For example, computer system 101 can maintain a database that stores an entry for each customer that has visited a particular store during a specified time period.

To incentivize a customer to visit a particular store, these entries can be used to implement a drawing to determine a customer that will receive an award. For example, after a specified period of time, computer system 101 can be configured to randomly select one or more entries that were stored during the specified period of time. The customer associated with a selected entry is the winner of the drawing.

For example, a drawing can be held once a week for all customers who checked in to a store during the week. Other time periods could also be specified for drawings. For example, if a retail store desires to increase the number of customers that visit at a particular time (e.g. on Tuesday mornings), a drawing can be held for all customers that visit during the particular time.

To notify a customer that he was selected as a winner of the drawing, computer system 101 can send a notification to the customer's computer device (e.g. computer device 102). This notification can be an email, text message, or similar message, or can be a notification to another application on the customer's computer device. For example, in cases where computer device 102 is a mobile phone, the same application (e.g. a smart phone app) can be used to register a visit to a particular store and to receive a notification that the customer has won a drawing.

In some embodiments, the notification can cause the customer's computer device to generate an audible sound that alerts the customer that he has won the drawing. An application on the computer device can also display to the customer what prize was won.

In some embodiments, the award can be in the form of one or more coupons for products available at the particular store. In such embodiments, the one or more coupons can be redeemed to receive a discount (up to 100%) off the purchase price. For example, if computer device 102 were a mobile phone, computer system 101 could send one or more coupons to computer device 102. Computer device 102 can display these coupons to the customer.

Another embodiment of the present invention records and reports to a server the number of times that an application on the portable computer device has been activated in a qualifying store. If that number exceeds a predetermined minimum, the participant will be sent by the server a message that they have qualified for an award. Receipt of a monthly award also qualifies them as a candidate for an annual randomized award.

In another embodiment, a daily award is offered by the store, and a monthly award is offered by a third party such as one of the companies offering the coupons. Points are awarded to the individual every time the coupon application is opened. These points allow the user greater opportunities to win a monthly award. The points can be allocated such that every x points allows one entry, so that more points provide more entries and a greater likelihood of winning. The points are only allocated if the application is opened and used in a qualified or participating store. Use is verified at the check-out counter or point of sale when digital coupons are used.

Similarly, points aggregate to provide greater chances of winning an annual award. This award is also provided by a third party, and is large enough to incentivize use of the application in stores. Qualification may follow the same scheme as the monthly award, or may use another formula to allow the points to increase the probability of winning.

Computer device 102 can also provide a way (e.g. a button) for the customer to redeem the coupons. For example, the customer can gather the products to which the coupons apply and carry them to the checkout counter. In such embodiments, computer system 101 can include (or can be interfaced with) a computer at the checkout counter (e.g. the POS system).

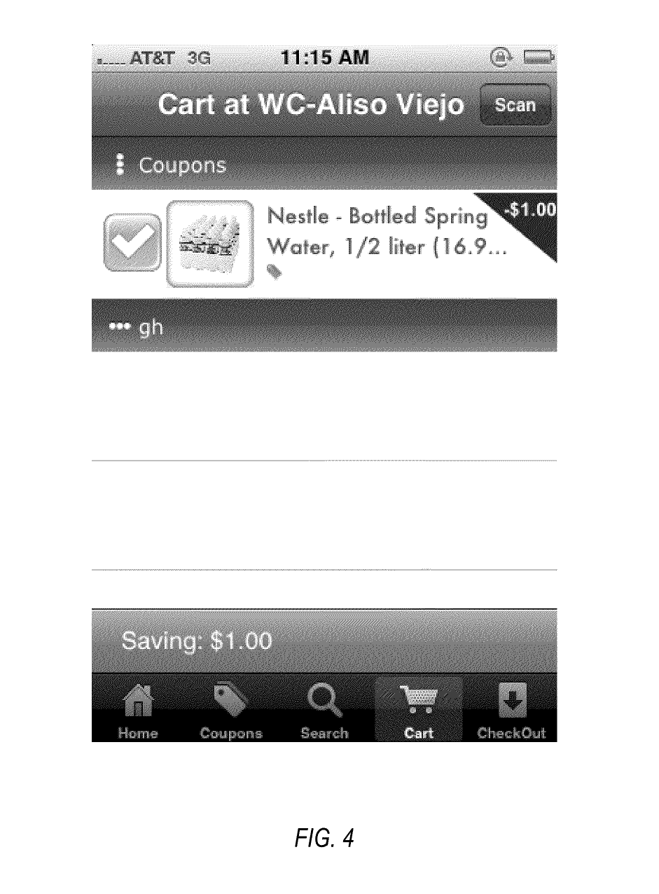

When the customer selects to redeem the coupons (e.g. by clicking a Redeem button on a mobile phone application that displays the coupons to the customer on the customer's mobile phone), computer device 102 can transmit the coupons (or information describing the coupons) to the computer at the checkout counter so that the appropriate price reduction is applied to the customer's checkout total. FIG. 4 illustrates an exemplary user interface of a mobile phone application for allowing the customer to select which coupons to redeem during checkout.

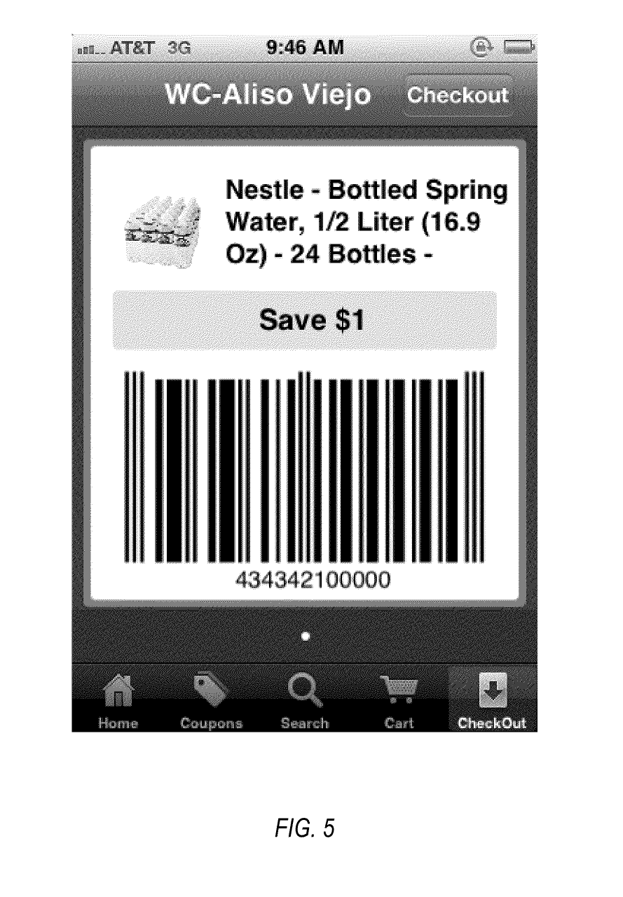

Alternatively or additionally, computer device 102 can display a barcode or other code that can be entered directly into the computer at the checkout stand to redeem each coupon. FIG. 5 illustrates an exemplary user interface of a mobile phone application for allowing the customer to redeem a coupon by scanning a barcode displayed on the mobile phone.

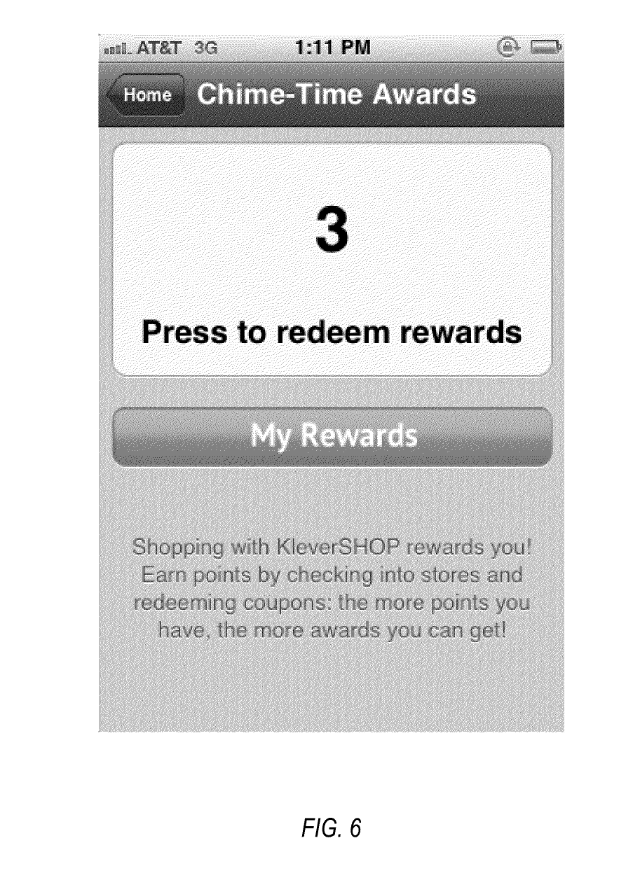

In some embodiments, the award can be in the form of points that are redeemable for coupons. For example, computer system 101 can implement a points bank which stores points accrued by customers. FIG. 6 illustrates an exemplary user interface of a mobile application for displaying a customer's accumulated points. Points can be accrued in various ways such as by shopping at particular retail stores or using coupons. With respect to the present invention, the winner of a drawing can be awarded a certain number of points that can be exchanged for coupons.

In some embodiments, the winning customer can be given the option to receive coupons or points. For example, if the winning customer is presented with coupons upon winning a drawing, but determines that he is not interested in the products to which the coupons apply, the customer can elect to receive points in place of the coupons. Alternatively, a customer could specify beforehand (e.g. upon registering an account) that he prefers points over coupons in which case, the customer can be awarded points anytime the award can be either coupons or points.

In some embodiments, customers can be provided the ability to specify which products the customers would like to be awarded in future drawings. For example, computer system 101 can cause a notification of upcoming or current drawings to be sent to any computer device that has registered to receive such notifications. These notifications can include a listing of coupons that will be awarded in the corresponding drawing.

A customer receiving a notification of a drawing can respond to the notification (e.g. via email, text, or using another app provided interface) specifying a product for which the customer would like to receive awards in future drawings. Computer system 101 can analyze this feedback provided by the customers in determining what coupons are offered in future drawings. For example, if a product is identified in at least a specified number of customer requests, a coupon can be offered for the product in a future drawing.

The techniques of the present invention can also be used to give awards to customers while they are in the retail store. Computer system 101 can provide an interface that allows the retail store to view all customers that are currently checked into the store. This information can be used to give an immediate award to one or more customers in the retail store.

This real-time award system is particularly beneficial in awarding products that may be approaching an expiration date or products of which the retail store has an excess. For example, if the retail store has fifty loaves of bread that will be expiring at the end of the day, the retail store can use computer system 101 to identify the customers that are present in the store and cause a notification to be sent to one or more customers that they have won a free loaf of bread. The customers can be specifically or randomly selected. A retail store can also use computer system 101 to configure the automatic selection of some number of customers per time period to receive an award. For example, a retail store can use computer system 101 to provide an award to five customers each hour.

The award system of the present invention also provides a way for manufacturers to promote their products. For example, a manufacturer can use the award system as a form of advertisement. The manufacturer can fund the award (e.g. provide coupons or cash that are redeemable for the manufacturer's products). Computer system 101 will then send out notifications that the manufacturer's products will be featured as the award for an upcoming drawing thus promoting the manufacturer's products directly to the customers that are most likely to shop at the retail store.

As stated above, the present invention can be partially implemented using a mobile phone application (app). A customer can install the app on his smart phone and use the app to register a visit at a particular retail store, to receive notifications of which coupons are being awarded in a current drawing, to receive notifications of awards received, to redeem coupons, etc. The app can be configured to interface with computer system 101 to perform these functions. The app can be further configured to search for and present available coupons to a customer (e.g. coupons available at a particular store, for one or more particular products, etc.), and to provide other types of shopping assistance (e.g. shopping list creation and management, store locator, etc.).

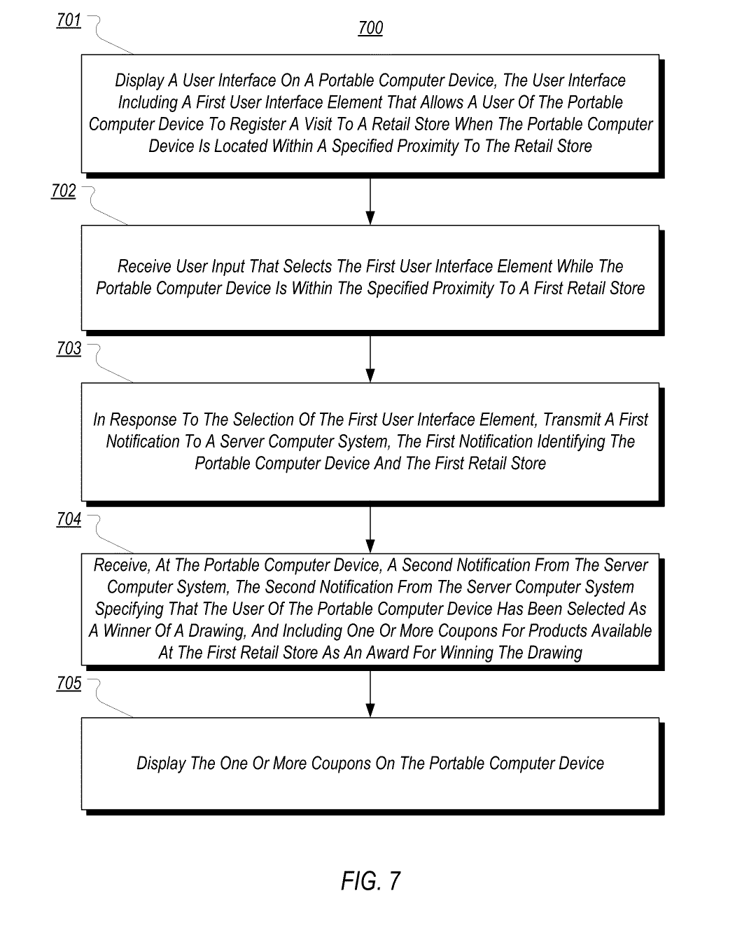

FIG. 7 illustrates a flowchart of an exemplary method 700 for participating in an award drawing. Method 700 will be described with reference to exemplary computing environment 100 of FIG. 1.

Method 700 includes an act 701 of displaying a user interface on a portable computer device, the user interface including a first user interface element that allows a user of the portable computer device to register a visit to a retail store when the portable computer device is located within a specified proximity to the retail store. For example, computer device 102 can display a user interface such as those shown in FIGS. 2 and 3 that provide a check-in button such as Check In button 201.

Method 700 includes an act 702 of receiving user input that selects the first user interface element while the portable computer device is within the specified proximity to a first retail store. For example, a user can select Check In button 201 while within a specified proximity of a store.

Method 700 includes an act 703 of, in response to the selection of the first user interface element, transmitting a first notification to a server computer system, the first notification identifying the portable computer device and the first retail store. For example, computer device 102 can transmit a notification to computer system 101 that identifies computer device 102 and the store that computer device 102 has checked into.

Method 700 includes an act 704 of receiving, at the portable computer device, a second notification from the server computer system, the second notification from the server computer system specifying that the user of the portable computer device has been selected as a winner of a drawing, and including one or more coupons for products available at the first retail store as an award for winning the drawing. For example, computer system 101 can send a notification to computer device 102 notifying the user of computer device 102 that he has won one or more coupons in a drawing.

Method 700 includes an act 705 of displaying the one or more coupons on the portable computer device. For example, coupons won in the drawing can be displayed on computer device 102.

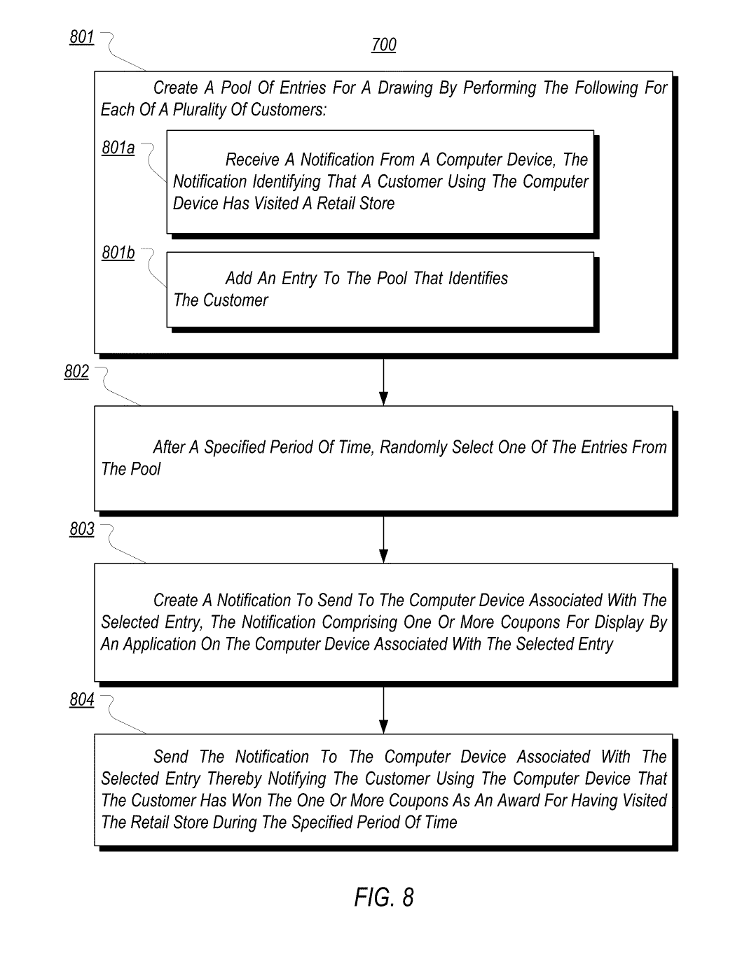

FIG. 8 illustrates a flowchart of an exemplary method 800 for incentivizing customer loyalty using awards. Method 800 will be described with reference to exemplary computing environment 100 of FIG. 1.

Method 800 includes an act 801 of creating a pool of entries for a drawing. For example, computer system 101 can create a pool of entries for a drawing.

Act 801 includes sub-act 801a of receiving a notification from a computer device, the notification identifying that a customer using the computer device has visited a retail store. For example, computer system 101 can receive notifications from computer devices such as computer device 102 which identify a customer using each computer device.

Act 801 includes sub-act 801b of adding an entry to the pool that identifies the customer. For example, computer system 101 can add an entry to the pool for each customer identified in a received notification.

Method 800 includes an act 802 of after a specified period of time, randomly selecting one of the entries from the pool. For example, computer system 101 can randomly select one of the entries in the pool.

Method 800 includes an act 803 of creating a notification to send to the computer device associated with the selected entry, the notification comprising one or more coupons for display by an application on the computer device associated with the selected entry. For example, computer system 101 can create a notification to send to computer device 102 if an entry associated with computer device 102 is selected as the winner of the drawing. The notification can include any coupons that were being awarded in the drawing.

Method 800 includes an act 804 of sending the notification to the computer device associated with the selected entry thereby notifying the customer using the computer device that the customer has won the one or more coupons as an award for having visited the retail store during the specified period of time. For example, computer system 101 can send the notification to computer device 102.

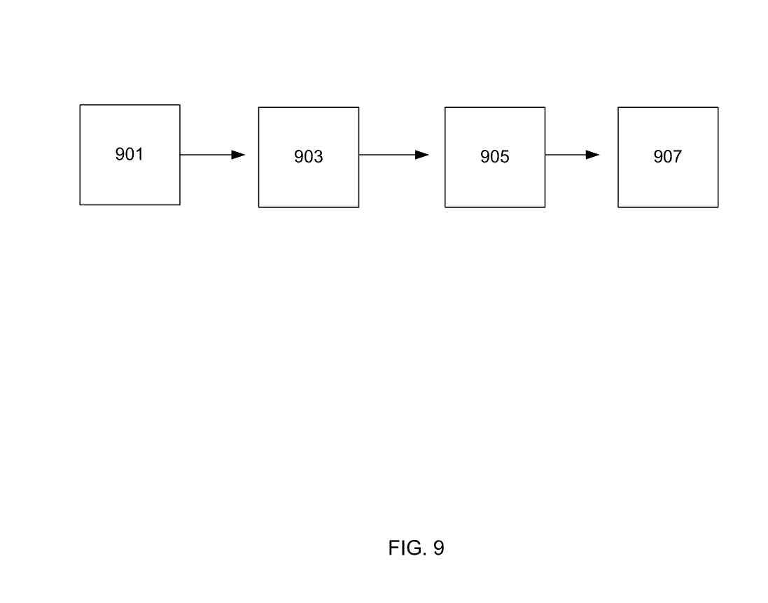

FIG. 9 illustrates a flowchart of a monthly or annual reward program wherein a user activates the coupon application on their portable computer device in a store and logs in. This usage is monitored 401 by the server and credit such as a point system is given to the user. This usage is aggregated 403 and the aggregated points are assigned to a reward schema. For example, every 2 points may result in an entry for that user being placed in a monthly randomized award drawing. More use of the coupon application by activating it in a authorized store will result in more entries in the drawing. These entries are made on the server 405 which then conducts a monthly randomized drawing from among the entrants. Users are notified 407 if they have received an award. Some embodiments may also have a consolation prize to encourage users to continue using the coupon application even if they do not receive the larger prize.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. One or more computer storage media storing computer executable instructions which when executed by one or more processors of a portable computer device perform a method for participating in an award drawing, the method comprising:
displaying a user interface on a portable computer device, the user interface including a first user interface element that allows a user of the portable computer device to register a visit to a retail store when the portable computer device is located within a specified proximity to the retail store;
receiving user input that selects the first user interface element while the portable computer device is within the specified proximity to a first retail store;
in response to the selection of the first user interface element, transmitting a first notification to a server computer system, the first notification identifying the portable computer device and the first retail store;
recording the activation of the portable computer device at the retail stores and allocating points for use; and
aggregating the points for participation in a monthly reward program.

2. The one or more computer storage media of claim 1, further comprising:
determining the location of the portable computer device when the user input is received using GPS data detected by the portable computer device; and
using the determined location to generate the first notification.

3. The one or more computer storage media of claim 1, wherein the user input includes an identification of the first retail store.

4. The one or more computer storage media of claim 1, further comprising:
in response to the selection of the first user interface element and prior to transmitting the first notification, receiving input to the portable computer device by scanning a barcode, the barcode providing an identifier of the first retail store to be included in the first notification.

5. The one or more computer storage media of claim 1, further comprising:
in response to receiving the second notification, playing an audible sound to indicate that the user has won the drawing.

6. The one or more computer storage media of claim 1, further comprising:
receiving user input that requests that the one or more coupons be redeemed; and
sending the one or more coupons to a computer system.

7. The one or more computer storage media of claim 6, wherein the computer system comprises a point of sale computer system at the first retail store.

8. The one or more computer storage media of claim 6, wherein the computer system is the server computer system.

9. The one or more computer storage media of claim 1, wherein the portable computer device is a mobile phone.

10. The one or more computer storage media of claim 9, further comprising:
receiving user input that selects the first user interface element while the mobile phone is within the specified proximity to a second retail store; and
in response to the selection of the first user interface element, transmitting a third notification to the server computer system, the third notification identifying the mobile phone and the second retail store.

11. The one or more computer storage media of claim 1, further comprising:
displaying a notification of a current or upcoming drawing;
receiving user input that requests that a response to the notification be generated;
receiving user input that specifies one or more products for which the customer desires coupons; and
generating and sending a notification that identifies the one or more specified products to the server computer system.

12. A method, performed by a portable computer system, for participating in an award drawing, the method comprising:
displaying a user interface on a portable computer device, the user interface including a first user interface element that allows a user of the portable computer device to register a visit to a retail store when the portable computer device is located within a specified proximity to the retail store and the coupon application is activated;
receiving user input that selects the first user interface element while the portable computer device is within the specified proximity to a first retail store;
in response to the selection of the first user interface element, transmitting a first notification to a server computer system, the first notification identifying the portable computer device and the first retail store;
using the coupon application at a point of sale to redeem coupons;
aggregating the number of activations and uses in approved retail stores;
receiving, at the portable computer device, a second notification from the server computer system, the second notification from the server computer system specifying that the user of the portable computer device has been entered for a monthly drawing, and including one or more coupons for products available at the first retail store as an award for qualifying for the monthly drawing;

13. The one or more computer storage media of claim 12, further comprising:
determining the location of the portable computer device when the user input is received using GPS data detected by the portable computer device; and
using the determined location to generate the first notification.

14. The one or more computer storage media of claim 12, wherein the user input includes an identification of the first retail store.

15. The one or more computer storage media of claim 12, further comprising:
in response to the selection of the first user interface element and prior to transmitting the first notification, receiving input to the portable computer device by scanning a barcode, the barcode providing an identifier of the first retail store to be included in the first notification.

16. The one or more computer storage media of claim 12, further comprising:
in response to receiving the second notification, playing an audible sound to indicate that the user has won the drawing.

17. The one or more computer storage media of claim 12, further comprising:
receiving user input that requests that the one or more coupons be redeemed; and
sending the one or more coupons to a computer system.

18. The one or more computer storage media of claim 17, wherein the computer system comprises a point of sale computer system at the first retail store.

19. The one or more computer storage media of claim 11, further comprising:
receiving user input that selects the first user interface element while the mobile phone is within the specified proximity to a second retail store; and
in response to the selection of the first user interface element, transmitting a third notification to the server computer system, the third notification identifying the mobile phone and the second retail store.

20. A computer system comprising:
one or more processors; and
computer storage media storing computer executable instructions which when executed by the one or more processors perform a method for incentivizing customer loyalty using awards, the method comprising:
creating a pool of entries for a drawing by performing the following for each of a plurality of customers:
receiving a notification from a computer device, the notification identifying that a customer using the computer device has visited an approved retail store and activated the coupon application; and
adding an entry to the pool that identifies the customer;
after a specified period of time, randomly selecting one of the entries from the pool;
creating a notification to send to the computer device associated with the selected entry, the notification comprising one or more coupons for display by an application on the computer device associated with the selected entry; and
sending the notification to the computer device associated with the selected entry thereby notifying the customer using the computer device that the customer has won the one or more coupons as an award for having visited the retail store during the specified period of time.
